(19) United States
(12) Patent Application Publication
(10) Pub. No.: US 2005/0195796 A1
(43) Pub. Date: Sep. 8, 2005

(54) Apparatus and method for recording a call statement made via an Internet telephone

(76) Inventor: Sang-Lak Lee, Seoul (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 10/792,901

(22) Filed: Mar. 5, 2004

(51) Int. Cl. H04L 12/66

(52) U.S. Cl. 370/352; 370/395.52

(57) ABSTRACT

Sound data received via an Internet telephone is recorded by hooking it, regardless of a network protocol, without analyzing the network protocol under VoIP environments. As a result, it is possible to easily record a calls Internet phone callers regardless of the kind of the Internet phones being used, the kind of network protocol being employed, depending on manufacturer, or whether the VoIP protocol has been upgraded.

### BACKGROUND AND SUMMARY

### TECHNICAL FIELD

The present invention relates to an Internet telephone, and more particularly, to an apparatus and method for recording a call statement of an Internet telephone.

Generally, services of a call center operated in companies or institutions, i.e., services such as customer counseling, telemarketing, phone banking, etc., are provided by in-house counselors within a counsel room installed in an office through a facility, (e.g., a private-branch exchange (PBX), an ATM exchange, etc.) to which outside customer calls are concentrated.

In order to operate such a call center business, a number of counselors must provide service through a telephone network connected to the private-branch exchange (PBX). Thus, there is a shortcoming that high cost for construction and maintenance of related facilities is needed.

As one of the measures for reducing installation and maintenance costs depending on construction of a call center, an Internet phone has been employed. In a financial business with customers, or a counseling business with customers at a financial company, however, there is sometimes a need to record a telephone call.

In particular, in the case of a call center using an Internet phone, if it is desired to record a call statement between counselors and customers, there is used a method of analyzing a network protocol communicated over a voice over Internet protocol (hereinafter, referred to as “VoIP”) network and extracting only sound data from the analyzed data.

However, conventional technology of analyzing a network protocol communicated over the Internet network from Internet phones or VoIP phones to extract only voice signals from communication data, is difficult to technically implement in reality. Furthermore, Internet phones (i.e., VoIP terminals) that are currently being used adopt different network protocols in terms of hardware and software depending on manufacturers. In addition, since the network protocols are frequently updated, it is not preferred to implement equipment for recording a call statement according to the prior art.

Accordingly, it would be desirable to provide an apparatus and method for easily recording a telephone call statement of callers who speak by telephone using Internet phones or VoIP phones.

It would also be desirable to provide a recording apparatus and method for storing a call statement of an Internet phone, a VoIP phone, etc. and all sounds occurring in a computer.

It would further be desirable to provide a recording apparatus driven by an application program, for storing all sounds occurring through a sound card of a computer, and a method thereof.

Accordingly, in one aspect of the present invention, a software module that can hook sound data on a software basis is built in a computer operating system (OS) that interfaces an application program including an Internet phone program, a VoIP terminal program, etc., and a sound card, whereby the sound data exchanged between a device driver for the sound card and a sound dynamic linking library (DLL) can be extracted and stored.

As a result, the sound data within the OS can be processed on a software basis regardless of network protocols of VoIP terminals.

Additional advantages, aspects, and features of the invention will be set forth in part in the description which follows and in part will become apparent to those having ordinary skill in the art upon examination of the following or may be learned from practice of the invention.

It is to be understood that both the foregoing general description and the following detailed description of the present invention are exemplary and explanatory and are intended to provide further explanation of the invention as claimed.

### BRIEF DESCRIPTION OF THE DRAWINGS

The above and other objects, features and advantages of the present invention will be apparent from the following detailed description of the preferred embodiments of the invention in conjunction with the accompanying drawing, in which:

FIG. 1 is a block diagram illustrating the configuration of a sound recording system for recording a call statement of an Internet phone according to one or more aspects of the present invention.

### DETAILED DESCRIPTION

Reference will now be made in detail to the preferred embodiments of the present invention, examples of which are illustrated in the accompanying drawing.

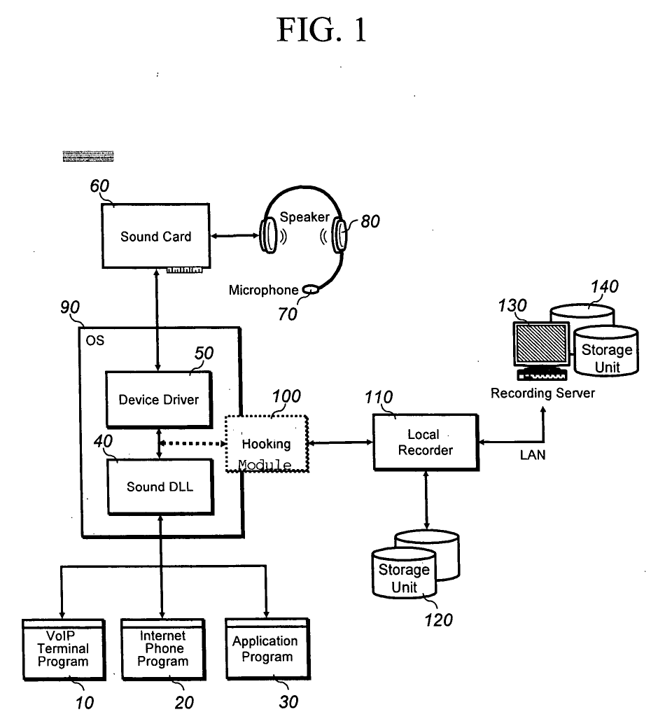

FIG. 1 is a block diagram illustrating the configuration of a sound recording system for recording a call performed with an Internet phone.

Referring to FIG. 1, a VoIP terminal 10 program, an Internet phone 20 program, or other application program 30 runs on a computer operating system (OS) 90.

The sound recording system of FIG. 1 is characterized in that it records/stores not only a call statement of the VoIP terminal 10 or the Internet phone 20, but also sound data generated by the other application programs 30 in the same manner. As such, the application program 30 or the Internet phone 20 is interfaced to the computer OS through a sound dynamic linking library (hereinafter, referred to as “DLL”) 40.

Meanwhile, the sound DLL 40 transmits the sound data to a device driver 50 that drives a sound card 60. In terms of hardware, the sound card 60 is connected to a microphone 70 and/or a speaker 80. Then, the sound card 60 outputs sound data to the speaker 80, and/or transmits sound inputted via the microphone 70 to the device driver 50.

Furthermore, sound data exchanged between the sound DLL 40 and the device driver 50 are extracted through a hooking program module 100. As such, by hooking (extracting) the sound data exchanged between the sound DLL 40 and the device driver 50 on the computer OS 90, it is possible for the VoIP terminal 10 or the Internet phone 20 to easily hook sound even if it does not know a network protocol that allows for communications with the VoIP network.

Meanwhile, the sound data extracted by the hooking program module 100 according to the present invention can be stored in a local storage unit 120 (e.g., a disk drive, an optical drive, a magnetic tape, semiconductor memory, etc.) through a local recorder 110. The stored sound data also may be transmitted to a recording server 130 via a local area network (LAN), so that the sound data are managed in a shared storage unit 140 (e.g., a disk drive, an optical drive, a magnetic tape, semiconductor memory, etc.) in a more centrally concentrated manner for a plurality of computers. Alternatively, the local storage unit 120 may be omitted and all sound data may only be stored on the shared storage unit 140. Beneficially, the computer OS may be Microsoft's Windows OS.

As described above, sound data can be recorded by hooking them regardless of a network protocol without analyzing the network protocol under VoIP environments.

As a result, it is possible to easily record a call made via Internet phones regardless of the kinds of the Internet phones employed using different network protocols depending on manufacturers, and protocols being upgraded, etc.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

Although the invention has been illustrated and described with respect to exemplary embodiments thereof, it should be understood by those skilled in the art that various other changes, omissions and additions may be made therein and thereto, without departing from the spirit and scope of the present invention.

Therefore, the present invention should not be understood as limited to the specific embodiment set forth above but to include all possible embodiments which can be embodies within a scope encompassed and equivalents thereof with respect to the feature set forth in the appended claims.

1. A method of recording sound generated by a voice over Internet Protocol (VoIP) terminal, an Internet phone, or an application program, which are operating on a computer operating system (OS), the method comprising:
passing the sound data from one of a VoIP terminal, an Internet phone, or an application program, to a sound data link library (DLL);
hooking sound data that is exchanged between the sound DLL and a device driver for interfacing with a sound card;
forwarding the hooked sound data to a local recorder; and
recording the sound data onto a data storage unit.

2. The method of claim 1, wherein a plurality of local computers each hook the sound data, and further comprising:
transmitting the sound data from the local recorder to a recording server via a local area network (LAN); and
recording the sound data onto a shared data storage unit that is shared between the plurality of computers.

3. An apparatus for recording sound generated by a VoIP terminal, an Internet phone or an application program that operates on a computer operating system (OS), the apparatus comprising:
a device driver for interfacing with a sound card connected to a microphone and/or a speaker to generate the sound;
a sound data link library (DLL) for interfacing between the device driver and one of a VoIP terminal, an Internet phone, and an application program; and
a sound-hooking module for hooking and extracting sound data exchanged between the device driver and the sound DLL.

4. The apparatus as claimed in claim 3, further comprising:
a local recorder for receiving the sound data outputted from the sound-hooking module; and
a local storage unit for storing the sound data received by the local recorder.

5. The apparatus as claimed in claim 3, further comprising:
a local recorder for receiving the sound data outputted from the sound-hooking module;
a recording server connected to the local recorder via a local area network (LAN), for managing the sound data received from the local recorder in a centrally concentrated manner; and
a shared storage unit for storing the sound data under the control of the recording server.

6. An apparatus for recording sound generated by a VoIP terminal, an Internet phone or an application program that operates on a computer operating system (OS), the apparatus comprising:
a device driver for interfacing with a sound card connected to a microphone and/or a speaker to generate the sound;
a sound data link library (DLL) for interfacing between a VoIP terminal, an Internet phone, and an application program and a device driver; and
a sound-hooking module for hooking and extracting sound data exchanged between the device driver and the sound DLL; and
data storage means for storing the sound data extracted by the sound-hooking module.

7. The apparatus of claim 6, where the data storage means is connected with the sound-hooking module via a local area network.
